(19) United States
(12) Patent Application Publication
(10) Pub. No.: US 2024/0192579 A1
(43) Pub. Date: Jun. 13, 2024

(54) WAVELENGTH SELECTIVE PHASE DIFFERENCE ELEMENT AND PROJECTION DISPLAY APPARATUS

(71) Applicant: SONY GROUP CORPORATION, TOKYO (JP)

(72) Inventor: KEISUKE HOMMA, TOKYO (JP)

(21) Appl. No.: 18/553,431

(22) PCT Filed: Feb. 16, 2022
(86) PCT No.: PCT/JP2022/006273

§ 371 Date: Sep. 29, 2023

(30) Foreign Application Priority Data
Apr. 8, 2021 (JP) 2021-066053

(51) Int. Cl. G03B 21/20; G02B 27/28

(52) U.S. Cl. CPC G03B 21/2073; G02B 27/283; G03B 21/2013

(57) ABSTRACT

A wavelength selective phase difference element according to an embodiment of the present disclosure includes: a light incident surface and a light output surface that are opposed to each other in a Z-axis direction when three axes including an X axis, a Y axis, and a Z axis are orthogonal to one another; a first member that has a multi-layer structure where a plurality of layers are stacked between the light incident surface and the light output surface; and a second member that is disposed on the light output surface of the first member and has an optical axis parallel to the Z-axis direction.

### TECHNICAL FIELD

The present disclosure relates to a wavelength selective phase difference element including a phase difference material, and a projection display apparatus including the wavelength selective phase difference element.

### BACKGROUND ART

For example, PTL 1 discloses a phase difference compensation element (wavelength selective phase difference element) including a phase difference imparting and reflection preventing layer that is formed by optical multiple layers and first, second, and third birefringence layers. The first birefringence layer and the second birefringence layer are each a layer in which an angle formed by a main axis of refractive index anisotropy and a surface of a transparent substrate is not 90 degrees, and the third birefringence layer is a layer in which an angle formed by a main axis of refractive index anisotropy and the surface of the transparent substrate is 0 degrees. With regard to the phase difference compensation element, respective segments of segment A, segment B, and segment C are acquired when the main axes of the first birefringence layer, the second birefringence layer, and the third birefringence layer are projected onto the transparent substrate. In this case, an angle formed by the segment A and the segment B is 45 degrees or more and 70 degrees or less, and the segment A and the segment C are approximately parallel with each other, or the segment B and the segment C are approximately parallel with each other. This makes it possible to improve contrast of a liquid crystal display device.

### CITATION LIST

### Patent Literature

PTL 1: Japanese Unexamined Patent Application Publication No. 2018-97071

### SUMMARY OF THE INVENTION

Meanwhile, for example, it has been desired for the wavelength selective phase difference element to improve its angular characteristics

It is desirable to provide a wavelength selective phase difference element and a projection display apparatus that make it possible to improve angular characteristics.

A wavelength selective phase difference element according to an embodiment of the present disclosure includes: a light incident surface and a light output surface that are opposed to each other in a Z-axis direction when three axes including an X axis, a Y axis, and a Z axis are orthogonal to one another; a first member that has a multi-layer structure where a plurality of layers are stacked between the light incident surface and the light output surface; and a second member that is disposed on the light output surface of the first member and has an optical axis parallel to the Z-axis direction.

A projection display apparatus according to an embodiment of the present disclosure includes: one or a plurality of light sources that emits light beams of a plurality of wavelength bands different from one another; a wavelength selection element that transmits or reflects light having a predetermined wavelength component among the light beams emitted from the light source: a plurality of light modulation elements that modulates respective light beams of the plurality of wavelength bands: a color combining element that combines the respective light beams of the wavelength bands emitted from the plurality of modulation elements: a projection optical system that projects light emitted from the color combining element: and a wavelength selective phase difference element that is disposed on a light output side of the wavelength selection element. The wavelength selective phase difference element included in the projection display apparatus is the wavelength selective phase difference element according to the above-described embodiment of the present disclosure.

When the three axes including the X axis, the Y axis, and the Z axis are orthogonal to one another, the wavelength selective phase difference element according to the embodiment of the present disclosure and the projection display apparatus according to the embodiment of the present disclosure include the second member that has the optical axis parallel to the Z-axis direction and that is disposed on the light output surface of the first member having a multi-layer structure where the plurality of layers are stacked between the light output surface and the light incident surface that are opposed to each other in the Z-axis direction. This makes it possible to offset an optical path length difference that arises when light incident perpendicularly on the first member and the light incident obliquely on the first member penetrate the first member.

### BRIEF DESCRIPTION OF THE DRAWINGS

FIG. 1 is a schematic cross-sectional view of an example of a configuration of a wavelength selective phase difference element according to an embodiment of the present disclosure.

FIG. 2 is a schematic exploded view describing the configuration of the wavelength selective phase difference element illustrated in FIG. 1.

FIG. 3 is a diagram illustrating an index ellipsoid of a first layer and a second layer and an index ellipsoid of a third layer that are viewed from a light traveling direction, the first layer, the second layer, and the third layer being included in a wavelength selective phase difference layer illustrated in FIG. 1 as a comparative example.

FIG. 4A is a diagram describing normal incident light and angled incident light that are incident from an azimuth A on the index ellipsoids illustrated in FIG. 3.

FIG. 4B is a diagram describing normal incident light and angled incident light that are incident from an azimuth B on the index ellipsoids illustrated in FIG. 3.

FIG. 4C is a diagram describing normal incident light and angled incident light that are incident from an azimuth C on the index ellipsoids illustrated in FIG. 3.

FIG. 4D is a diagram describing normal incident light and angled incident light that are incident from an azimuth D on the index ellipsoids illustrated in FIG. 3.

FIG. 5 is a diagram illustrating the index ellipsoid of the first layer and the second layer, the index ellipsoid of the third layer, and an index ellipsoid of an angle compensation layer viewed from a light traveling direction, the first layer, the second layer, the third layer, and the angle compensation layer being included in the wavelength selective phase difference element illustrated in FIG. 1.

FIG. 6A is a diagram describing normal incident light and angled incident light that are incident from an azimuth A on the index ellipsoids illustrated in FIG. 5.

FIG. 6B is a diagram describing normal incident light and angled incident light that are incident from an azimuth B on the index ellipsoids illustrated in FIG. 5.

FIG. 6C is a diagram describing normal incident light and angled incident light that are incident from an azimuth C on the index ellipsoids illustrated in FIG. 5.

FIG. 6D is a diagram describing normal incident light and angled incident light that are incident from an azimuth D on the index ellipsoids illustrated in FIG. 5.

FIG. 7 is a diagram illustrating optical properties of the wavelength selective phase difference element that has a three-layered structure as the comparative example.

FIG. 8 is a diagram illustrating optical properties of the wavelength selective phase difference element illustrated in FIG. 1.

FIG. 9 is a diagram illustrating optical properties of a wavelength selective phase difference element that has a four-layered structure as a comparative example.

FIG. 10 is a diagram illustrating optical properties obtained when the present technology is applied to the wavelength selective phase difference element that has the four-layered structure.

FIG. 11 is a schematic cross-sectional view of an example of a configuration of a wavelength selective phase difference element according to a modification example of the present disclosure.

FIG. 12 is a diagram illustrating an index ellipsoid of a first layer and a second layer, an index ellipsoid of a third layer, and an index ellipsoid of an angle compensation layer viewed from a light traveling direction, the first layer, the second layer, the third layer, and the angle compensation layer being included in the wavelength selective phase difference element illustrated in FIG. 11.

FIG. 13A is a diagram describing normal incident light and angled incident light incident from an azimuth A on the index ellipsoids illustrated in FIG. 12.

FIG. 13B is a diagram describing normal incident light and angled incident light incident from an azimuth B on the index ellipsoids illustrated in FIG. 12.

FIG. 13C is a diagram describing normal incident light and angled incident light incident from an azimuth C on the index ellipsoids illustrated in FIG. 12.

FIG. 13D is a diagram describing normal incident light and angled incident light incident from an azimuth D on the index ellipsoids illustrated in FIG. 12.

FIG. 14 is a schematic cross-sectional view of another example of a configuration of a wavelength selective phase difference element according to the modification example of the present disclosure.

FIG. 15 is a schematic cross-sectional view of another example of a configuration of a wavelength selective phase difference element according to the modification example of the present disclosure.

FIG. 16 is a schematic cross-sectional view of another example of a configuration of a wavelength selective phase difference element according to the modification example of the present disclosure.

FIG. 17 is a schematic diagram illustrating an example of a configuration of a projector that is an application example of the present disclosure.

FIG. 18 is a schematic diagram illustrating another example of a configuration of a projector that is an application example of the present disclosure.

FIG. 19 is a schematic diagram illustrating another example of a configuration of a projector that is an application example of the present disclosure.

FIG. 20 is a schematic diagram illustrating another example of a configuration of a projector that is an application example of the present disclosure.

FIG. 21 is a schematic diagram illustrating another example of a configuration of a projector that is an application example of the present disclosure.

### MODES FOR CARRYING OUT THE INVENTION

Next, with reference to drawings, details of embodiments of the present disclosure is described. The following description is a specific example of the present disclosure, and the present disclosure is not limited to the following modes. In addition, the present disclosure is not limited to placements, dimensions, dimensional ratios, and the like of respective structural elements in each diagram. It is to be noted that, the description is given in the following order.
1. Embodiment (An example of a wavelength selective phase difference element including ab angle compensation layer disposed on a light output surface, the angle compensation layer having an optical axis that is parallel to a stacking direction)
2. Modification example (Another example of a configuration of a wavelength selective phase difference element)
3. Application Examples

### 1. EMBODIMENT

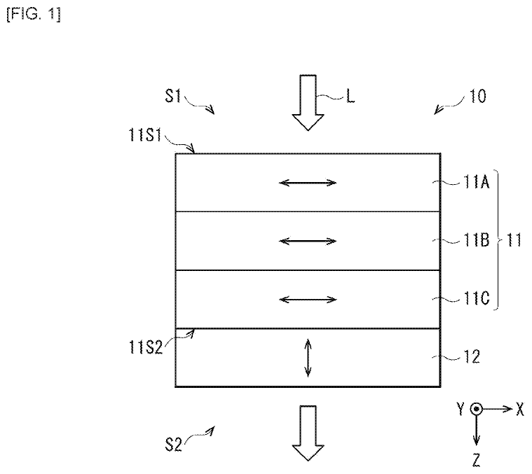

FIG. 1 schematically illustrates a cross-sectional configuration of a wavelength selective phase difference element (a wavelength selective phase difference element 10) according to an embodiment of the present disclosure. The wavelength selective phase difference element 10 is, for example, a phase difference plate that has a feature of rotating a polarization direction only in a selective wavelength band and that is used for a projection display apparatus (for example, a projector 1 (FIG. 17)) to be described later. When three axes including an X axis, a Y axis, and a Z axis are orthogonal to one another, the wavelength selective phase difference element 10 according to the present embodiment includes an angle compensation layer 12 disposed on a light output surface 11S2 of a wavelength selective phase difference layer 11. The angle compensation layer 12 has an optical axis parallel to a Z-axis direction, and the wavelength selective phase difference layer 11 includes the light incident surface 11S1 and a light incident surface 11S2 opposed to each other in the Z-axis direction.

### [Configuration of Wavelength Selective Phase Difference Element]

As described above, the wavelength selective phase difference element 10 has the feature of rotating a polarization direction only in a selective wavelength band (for example, red band, green band, or blue band). The wavelength selective phase difference element 10 includes a wavelength selective phase difference layer 11 disposed on a side of a light incident surface S1, and an angle compensation layer 12 disposed on a side of a light output surface S2. The wavelength selective phase difference layer 11 corresponds to a specific example of a “first member” according to the present disclosure, and the angle compensation layer 12 corresponds to a specific example of a “second member” according to the present disclosure. The wavelength selective phase difference layer 11 includes a plurality of layers, and has a stacked structure where a first layer 11A, a second layer 11B, and a third layer 11C are bonded in this order from a side of a light incident surface 11S1 of the light incident surface 11S1 and a light output surface 11S2 opposed to each other.

The wavelength selective phase difference layer 11 including the first layer 11A, the second layer 11B, and the third layer 11C is a plate-like member having a thickness of 0.010 mm or more and 3.000 mm or less, for example. The first layer 11A, the second layer 11B, and the third layer 11C include a phase difference material such as a uniaxial crystal or a uniaxial organic material. Specific examples of the phase difference material include crystal, sapphire, yttrium vanadate, lithium niobate, polycarbonate, polypropylene, and the like.

As described above, the first layer 11A, the second layer 11B, and the third layer 11C are bonded in this order. For example, light L enters the light incident surface 11S1, penetrates the first layer 11A, the second layer 11B, and the third layer 11C in this order, and outputs through the light output surface 11S2. In FIG. 1, the Z axis represents an incident direction of the light L and a direction of bonding the first layer 11A, the second layer 11B, and the third layer 11C.

It is to be noted that the phase difference material included in the first layer 11A, the second layer 11B, and the third layer 11C is not limited to the uniaxial crystal or the uniaxial organic material, but may be a biaxial crystal or a biaxial organic material.

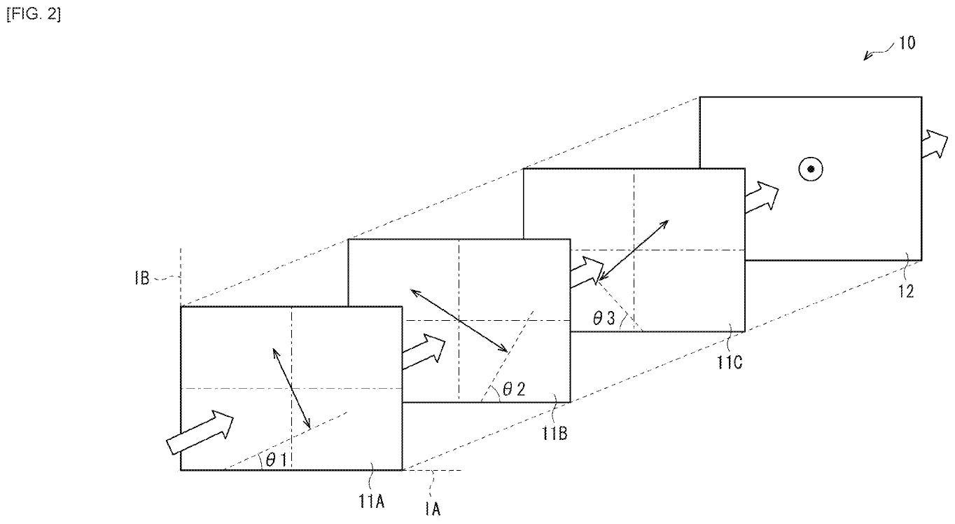

The first layer 11A, the second layer 11B, and the third layer 11C each have an optical axis (for example, a slow axis) that is parallel to an XY-plane defined by an X-axis direction and a Y-axis direction. In addition, the optical axes of the first layer 11A, the second layer 11B, and the third layer 11C are different from each other in the XY-planes. The following is an example of a combination of the optical axes of the first layer 11A, the second layer 11B, and the third layer 11C. For example, as illustrated in FIG. 2, an angle θ1 formed by a reference side and a perpendicular line to the optical axis of the first layer 11A is about 73° (for example, 72.6°±0.5°), an angle θ2 formed by the reference side and a perpendicular line to the optical axis of the second layer 11B is about 37° (for example, 37.1°±0.5°), and an angle θ3 formed by the reference side and a perpendicular line to the optical axis of the third layer 11C is about 45° (for example, 44.8°±0.5°). Here, the “reference side” is defined as one of two sides 1A and 1B that are parallel or perpendicular to a vibration direction of incident polarization light. It is to be noted that the angles θ1 to θ3 are absolute values representing respective angles to the reference side 1A. In a case where the reference side 1B is used, the angles θ1, θ2, and θ3 are 17°, 53°, and 45°, respectively.

The angle compensation layer 12 is for offsetting a difference in optical path length that arises when light (normal incident light) L1 incident perpendicularly on the wavelength selective phase difference layer 11 and light (angled incident light) L2 incident obliquely on the wavelength selective phase difference layer 11 penetrate the first layer 11A, the second layer 11B, and the third layer 11C in this order. As described above, the angle compensation layer 12 has an optical axis parallel to the Z-axis direction, and is adjacently disposed on the light output surface 11S2 of the wavelength selective phase difference layer 11 such as the third layer 11C.

The angle compensation layer 12 is a plate-like member having a thickness of 0.010 mm or more and 3.000 mm or less, for example. The angle compensation layer 12 includes a phase difference material such as a uniaxial crystal or a uniaxial organic material. Specific examples of the phase difference material include crystal, sapphire, yttrium vanadate, lithium niobate, polycarbonate, polypropylene, and the like. It is to be noted that the phase difference material included in the angle compensation layer 12 is not limited to the uniaxial crystal or the uniaxial organic material, but may be the biaxial crystal or the biaxial organic material.

### [Workings and Effects]

As described above, when the three axes including the X axis, the Y axis, and the Z axis are orthogonal to one another, the wavelength selective phase difference element 10 according to the present embodiment includes the angle compensation layer 12 disposed on the light output surface 11S2 of the wavelength selective phase difference layer 11. The angle compensation layer 12 has the optical axis parallel to the Z-axis direction, and the wavelength selective phase difference layer 11 includes the first layer 11A, the second layer 11B, and the third layer 11C bonded in this order from the side of the light incident surface 11S1 between the light incident surface 11S1 and the light output surface 11S2 that are opposed to each other in the Z-axis direction. This makes it possible to offset an optical path length difference that arises when the light (normal incident light L1) incident perpendicularly on the light incident surface 11S1 and the light (angled incident light L2) incident obliquely on the light incident surface 11S1 penetrate the wavelength selective phase difference layer 11. A description thereof is provided below.

In general, though the wavelength selective phase difference element including a plurality of waveplate groups exhibits excellent optical properties (vertical property) related to normal incident light, an optical property (angular property) related to angled incident light has not been studied sufficiently yet. One reason for this is that it is necessary to increase the number of waveplates included in the wavelength selective phase difference element to improve the vertical property, but the angular property deteriorates as the number of waveplates, that is the thickness in a light traveling direction increases.

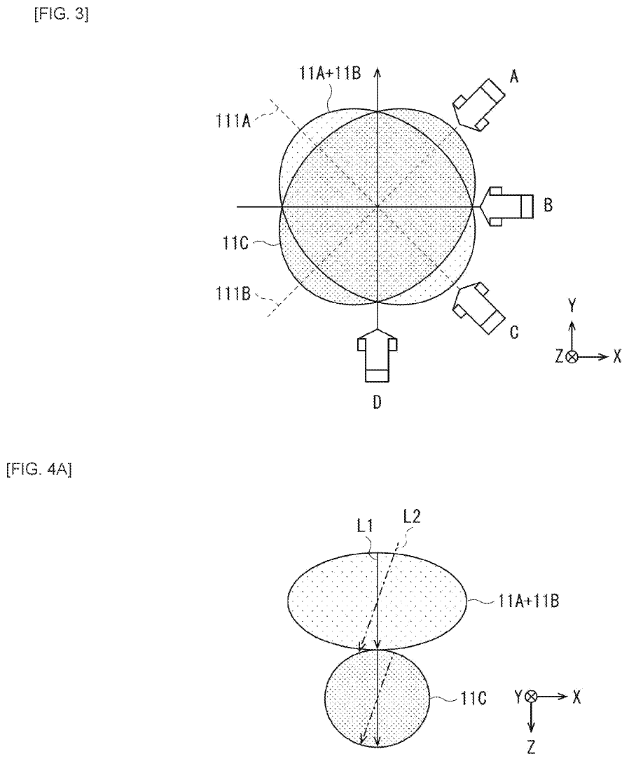

FIG. 3 is a diagram illustrating the first layer 11A, the second layer 11B, and the third layer 11C included in the wavelength selective phase difference layer 11 as the index ellipsoids when viewed from a traveling direction of the light L, the wavelength selective phase difference element corresponding to the general wavelength selective phase difference element. The first layer 11A, the second layer 11B, and the third layer 11C each have an example of the above-described optical axis (the slow axis). The first layer 11A and the second layer 11B are illustrated as a composite index ellipsoid (11A+11B). The first layer 11A, the second layer 11B, and the third layer 11C satisfy a relationship Ny>Nx=Nz, where Nx, Ny, and Nz respectively represent refractive indices in the X-axis direction, the Y-axis direction, and the Z-axis direction. The composite index ellipsoid (11A+11B) of the first layer 11A and the second layer 11B is rotated 135° counterclockwise, and has a slow axis 111A at an azimuth of 135°. With regard to the composite index ellipsoid (11A+11B) of the first layer 11A and the second layer 11B, the slow axis 111A rotated 135° counterclockwise serves as an X axis, and a direction perpendicular to the slow axis 111A serves as a Y axis. The index ellipsoid (11C) of the third layer 11C is rotated 45° counterclockwise, and has a slow axis 111B at an azimuth of 45°. With regard to the index ellipsoid (11C) of the third layer 11C, the slow axis 111B rotated 45° counterclockwise serves as an X axis, and a direction perpendicular to the slow axis 111B serves as a Y axis.

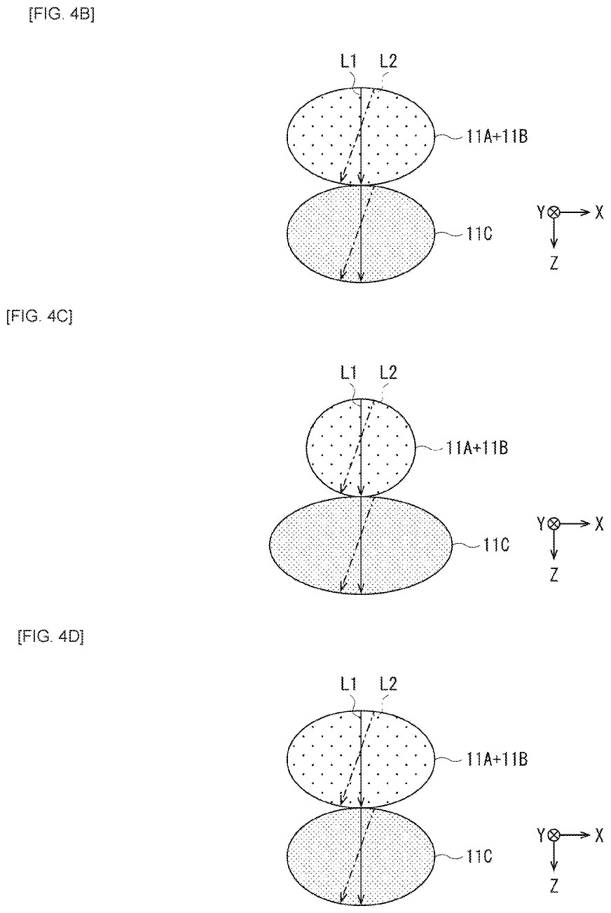

FIG. 4A to FIG. 4D schematically illustrate light (normal incident light L1) incident perpendicularly on the composite index ellipsoid (11A+11B) of the first layer 11A and the second layer 11B and the index ellipsoid of the third layer 11C, and light (angled incident light L2) incident obliquely from respective azimuths A, B, C, and D illustrated in FIG. 3. Table 1 shows optical path length differences that arise when the normal incident light L1 and the angled incident light L2 incident from the azimuths A to D penetrate the index ellipsoids. In Table 1, “0” represents a case where the normal incident light L1 and the angled incident light L2 have a same optical path length, “I” represents a case where the angled incident light L2 has a longer optical path length than the normal incident light L1, and “s” represents a case where the angled incident light L2 has a shorter optical path length than the normal incident light L1. “I” satisfies a magnitude relationship 1⁻<1<1⁺, and “s” satisfies a magnitude relationship s⁻<s<s⁺. It is to be noted that the same applies to Table 2 and Table 3 to be listed later.

TABLE 1

| Azimuth | 11A + 11B | 11C |
|---|---|---|
| A | 1⁺ | 0 |
| B | 1 | 1 |
| C | 0 | 1⁺ |
| D | 1 | 1 |

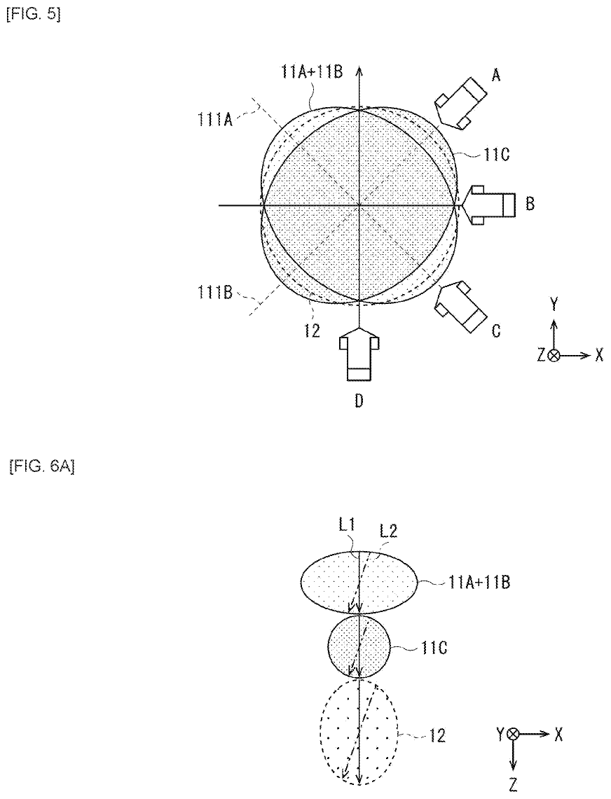

FIG. 5 is a diagram illustrating the first layer 11A, the second layer 11B, the third layer 11C, and the angle compensation layer 12 included in the wavelength selective phase difference element 10 as index ellipsoids according to the present embodiment when viewed from a traveling direction of the light L. The first layer 11A, the second layer 11B, and the third layer 11C each have an example of the above-described optical axis (slow axis). The first layer 11A and the second layer 11B are illustrated as a composite index ellipsoid (11A+11B). The first layer 11A, the second layer 11B, and the third layer 11C satisfy a relationship Ny>Nx=Nz, where Nx, Ny, and Nz respectively represent refractive indices in the X-axis direction, the Y-axis direction, and the Z-axis direction. The composite index ellipsoid (11A+11B) of the first layer 11A and the second layer 11B is rotated 135° counterclockwise, and has the slow axis 111A at an azimuth of 135°. With regard to the composite index ellipsoid (11A+11B) of the first layer 11A and the second layer 11B, the slow axis 111A rotated 135° counterclockwise serves as an X axis, and a direction perpendicular to the slow axis 111A serves as a Y axis. The index ellipsoid of the third layer 11C is rotated 45° counterclockwise, and has a slow axis 111B at an azimuth of 45°. With regard to the index ellipsoid (11C) of the third layer 11C, the slow axis 111B rotated 45° counterclockwise serves as an X axis, and a direction perpendicular to the slow axis 111B serves as a Y axis. The angle compensation layer 12 satisfies a relationship Nx=Ny<Nz, where Nx, Ny, and Nz respectively represent refractive indices in the X-axis direction, the Y-axis direction, and the Z-axis direction. Therefore, the index ellipsoid of the angle compensation layer 12 has a substantially circular shape when viewed from the traveling direction of the light L.

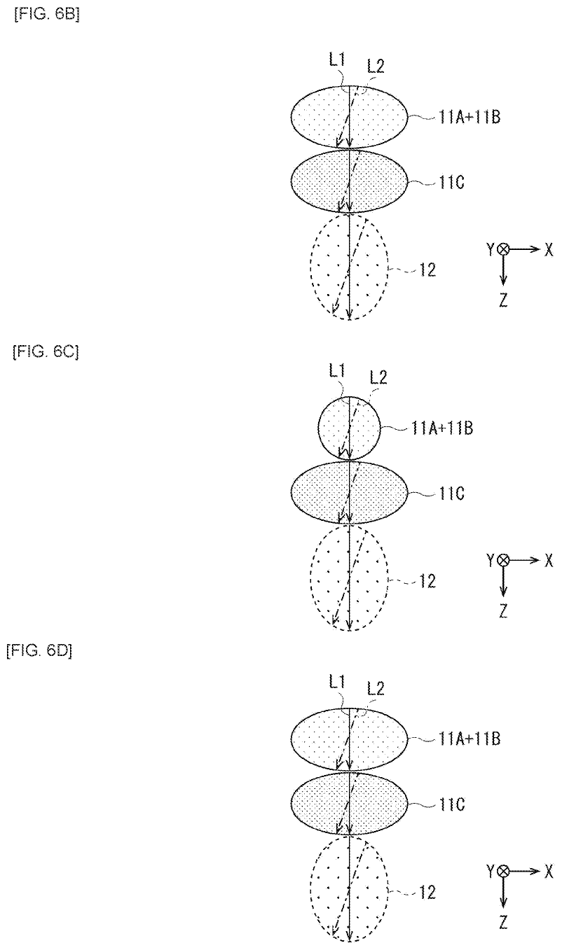

FIG. 6A to FIG. 6D schematically illustrate light (normal incident light L1) incident perpendicularly on the composite index ellipsoid (11A+11B) of the first layer 11A and the second layer 11B, the index ellipsoid of the third layer 11C, and the index ellipsoid of the angle compensation layer 12, and light (angled incident light L2) incident obliquely from respective azimuths A, B, C, and D illustrated in FIG. 5. Table 2 shows optical path length differences that arise when the normal incident light L1 and the angled incident light L2 incident from the azimuths A to D penetrate the index ellipsoids.

TABLE 2

| Azimuth | 11A + 11B | 11C | 12 |
|---|---|---|---|
| A | 1⁺ | 0 | s⁻ |
| B | 1 | 1 | s⁻ |
| C | 0 | 1⁺ | s⁻ |
| D | 1 | 1 | s⁻ |

For example, as illustrated in FIG. 3 and FIG. 4A to FIG. 4D, the index ellipsoids of the first layer 11A, the second layer 11B, and the third layer 11C included in the wavelength selective phase difference layer 11 have long axes in an XY in-plane direction. Therefore, at any of the azimuth A to azimuth D, the angled incident light L2 that penetrated only the wavelength selective phase difference layer 11 has a longer optical path length than the normal incident light L1 when penetrating one or both of the composite index ellipsoids of the first layer 11A and the second layer 11B and the index ellipsoid of the third layer 11C. Accordingly, the phase of the angled incident light L2 is shifted from the normal incident light L1.

On the other hand, as illustrated in FIG. 5 and FIG. 6A to FIG. 6D, the index ellipsoid of the angle compensation layer 12 has a long axis in the Z-axis direction, for example. Therefore, light (angled incident light L2) incident obliquely on the angle compensation layer 12 has a shorter optical path length than perpendicularly-incident light (normal incident light L1).

In the wavelength selective phase difference element 10 according to the present embodiment, the angle compensation layer 12 in which the optical path length of the angled incident light L2 is shorter than the optical path length of the normal incident light L1 is disposed on the light output surface 11S2 of the wavelength selective phase difference layer 11. This makes it possible to offset an optical path length difference that arises between the normal incident light L1 and the angled incident light L2 when penetrating the wavelength selective phase difference layer 11.

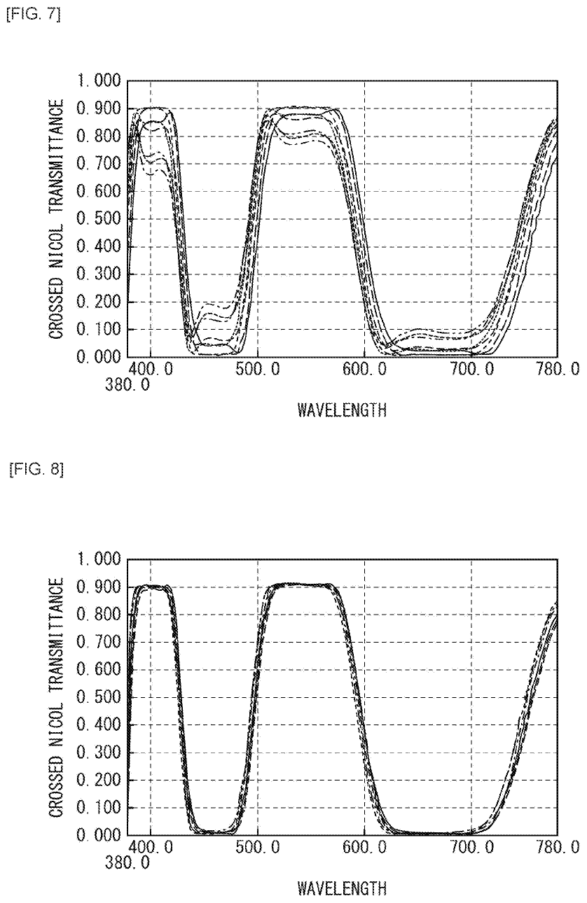

FIG. 7 illustrates crossed Nicol transmittances of light incident from different azimuths on the light incident surface 11S1 of the wavelength selective phase difference element including only the wavelength selective phase difference layer 11 according to the present embodiment, for example. The azimuths are 12° different from each other. FIG. 8 illustrates crossed Nicol transmittances of light incident from different azimuths on the light incident surface S1 (light incident surface 11S1) of the wavelength selective phase difference element 10 including the angle compensation layer 12 disposed on the light output surface 11S2 of the wavelength selective phase difference layer 11 according to the present embodiment, for example. The azimuths are 12° different from each other. In comparison with the wavelength selective phase difference element (FIG. 7) including only the wavelength selective phase difference layer 11, the wavelength selective phase difference element 10 (FIG. 8) according to the present embodiment makes it possible to selectively transmit light in the green band, and improve deterioration in the crossed Nicol transmittances.

As described above, in the wavelength selective phase difference element 10 according to the present embodiment, the angle compensation layer 12 having the optical axis parallel to the Z-axis direction is disposed on the light output surface 11S2 of the wavelength selective phase difference layer 11. This makes it possible to offset an optical path length difference that arises when the normal incident light L1 and the angled incident light L2 penetrate the wavelength selective phase difference layer 11, and it is possible to solve an issue of a phase difference between the normal incident light L1 and the angled incident light L2. In other words, it is possible to improve the angular property. Therefore, it is possible to provide the wavelength selective phase difference element having excellent vertical property and excellent angular property.

It is to be noted that though the example in which the wavelength selective phase difference layer 11 according to the present embodiment has a three-layered structure including the first layer 11A, the second layer 11B, and the third layer 11C has been described above, the present disclosure is not limited thereto.

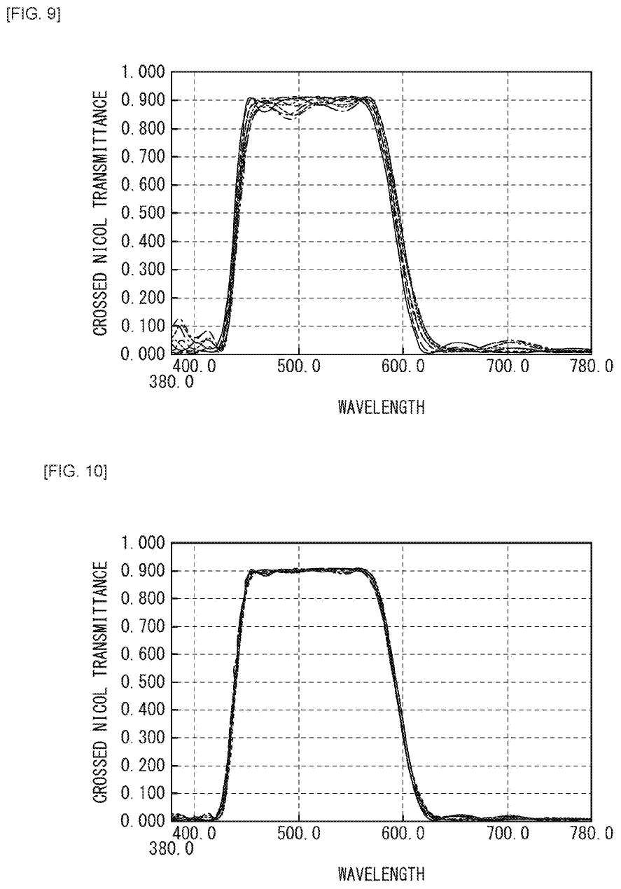

FIG. 9 illustrates crossed Nicol transmittances of light incident at an angle of 12° on a light incident surface of a wavelength selective phase difference element including four layers, for example. FIG. 10 illustrates crossed Nicol transmittances of light incident at an angle of 12° on the light incident surface of a wavelength selective phase difference element according to the present embodiment. The wavelength selective phase difference element according to the present embodiment includes the angle compensation layer 12 disposed on the light output surface of the wavelength selective phase difference element having the four-layered structure like FIG. 9. As illustrated in FIG. 10, the angle compensation layer 12 disposed on the light output surface makes it possible to selectively transmit light in the blue band to the green band, and improve deterioration in the crossed Nicol transmittances in comparison with FIG. 9, for example. In other words, the present technology makes it possible to improve the angular property regardless of the number of layers included in the wavelength selective phase difference layer 11.

Next, modification examples and application examples of the present disclosure are described. Hereinafter, structural elements that are similar to the above-described embodiment are denoted with the same reference signs as the above-described embodiment, and repeated description is appropriately omitted.

### 2. MODIFICATION EXAMPLES

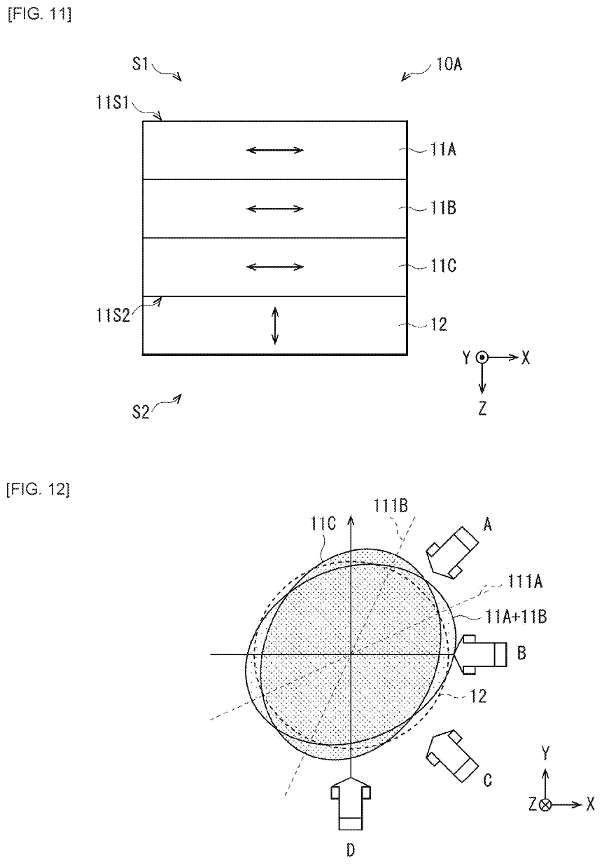

FIG. 11 schematically illustrates an example of a cross-sectional configuration of a wavelength selective phase difference element (wavelength selective phase difference element 10A) according to a modification example of the present disclosure. In a way similar to the above-described embodiment, the wavelength selective phase difference element 10A is, for example, a phase difference plate that has a feature of rotating a polarization direction only in a selective wavelength band and that is used for a projection display apparatus (for example, the projector 1 (FIG. 17)) to be described later.

According to the above-described embodiment, the example is illustrated in which the first layer 11A and the second layer 11B, and the third layer 11C included in the wavelength selective phase difference layer 11 respectively have slow axes of −73°, −37°, and 45°, or respectively have slow axes of 73°, 37°, and −45°, and the angle compensation layer 12 is adjacently disposed on the third layer 11C having the slow axis of 45°. However, the wavelength selective phase difference element according to the present technology is not limited thereto. The wavelength selective phase difference element 10A according to the present modification example is different from the wavelength selective phase difference element 10 according to the above-described embodiment in that the third layer 11C included in the wavelength selective phase difference element 10 is made into a layer that has a slow axis of 75°, for example.

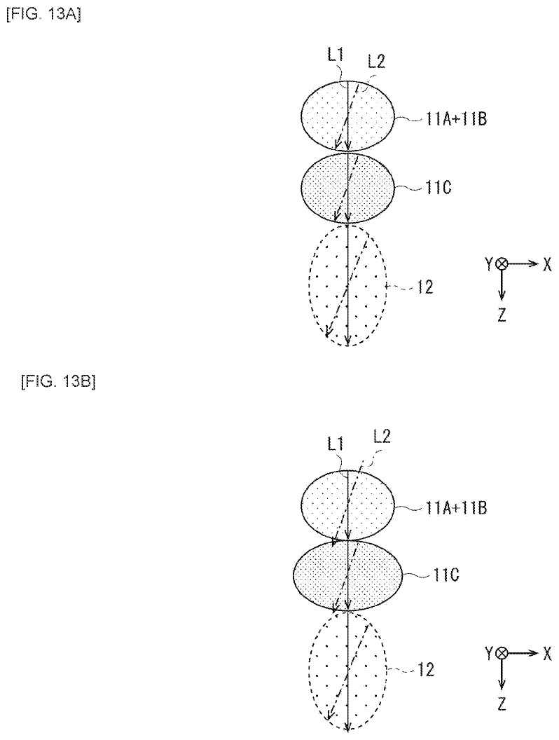

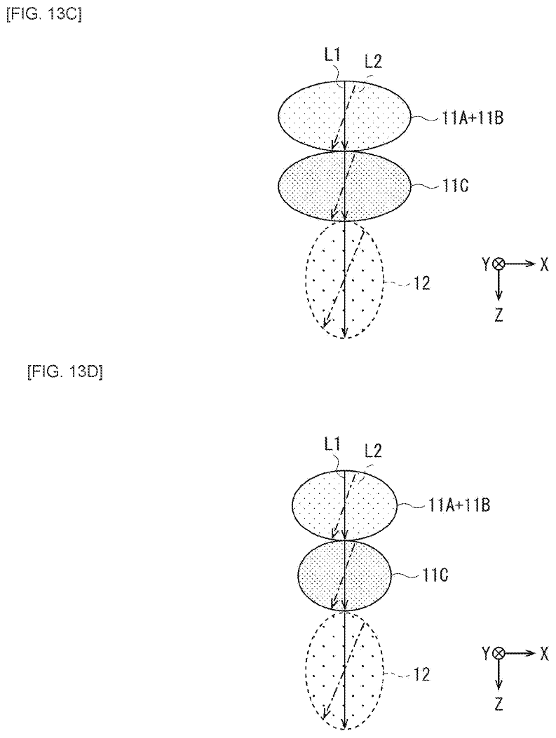

In a way similar to FIG. 5 and the like according to the above-described embodiment, FIG. 12 is a diagram illustrating the first layer 11A, the second layer 11B, the third layer 11C, and the angle compensation layer 12 included in the wavelength selective phase difference element 10A according to the present modification example as index ellipsoids when viewed from a traveling direction of the light L. According to the present modification example, the composite index ellipsoid of the first layer 11A and the second layer 11B is rotated 20° counterclockwise, and has the slow axis 111A at an azimuth of 20°. The index ellipsoid of the third layer 11C is rotated 75° counterclockwise, and has a slow axis 111B at an azimuth of 75°. The angle compensation layer 12 satisfies a relationship Nx=Ny<Nz, where Nx, Ny, and Nz respectively represent refractive indices in the X-axis direction, the Y-axis direction, and the Z-axis direction. The angle compensation layer 12 has a substantially circular shape when viewed from the traveling direction of the light L.

FIG. 13A to FIG. 13D schematically illustrate light (normal incident light L1) incident perpendicularly on the composite index ellipsoid (11A+11B) of the first layer 11A and the second layer 11B, the index ellipsoid of the third layer 11C, and the index ellipsoid of the angle compensation layer 12, and light (angled incident light L2) incident obliquely from respective azimuths A, B, C, and D illustrated in FIG. 12. Table 3 shows optical path length differences that arise when the normal incident light L1 and the angled incident light L2 incident from the azimuth A to the azimuth D penetrate the index ellipsoids.

TABLE 3

| Azimuth | 11A + 11B | 11C | 12 |
|---|---|---|---|
| A | 1⁻ | 1⁻ | s⁻ |
| B | 1⁻ | 1 | s⁻ |
| C | 1⁺ | 1⁺ | s⁻ |
| D | 1 | 1⁻ | s⁻ |

As described above, the layer disposed on a side of the light output surface 11S2 of the wavelength selective phase difference layer 11 adjacent to the angle compensation layer 12 does not have to have the slow axis of 45°. According to the present technology, by disposing the angle compensation layer 12 on the light output surface 11S2, it is possible to offset a certain amount of optical path length difference that arises between the normal incident light L1 and the angled incident light L2 when penetrating the wavelength selective phase difference layer 11 even in a case where a layer having a slow axis of an angle other than 45° is disposed on the side of the light output surface 11S2 of the wavelength selective phase difference layer 11. This makes it possible to improve the angular property.

In addition, wavelength selective phase difference elements 10 having the following configurations also make it possible to achieve effects similar to the wavelength selective phase difference element 10A according to the above-described modification example.

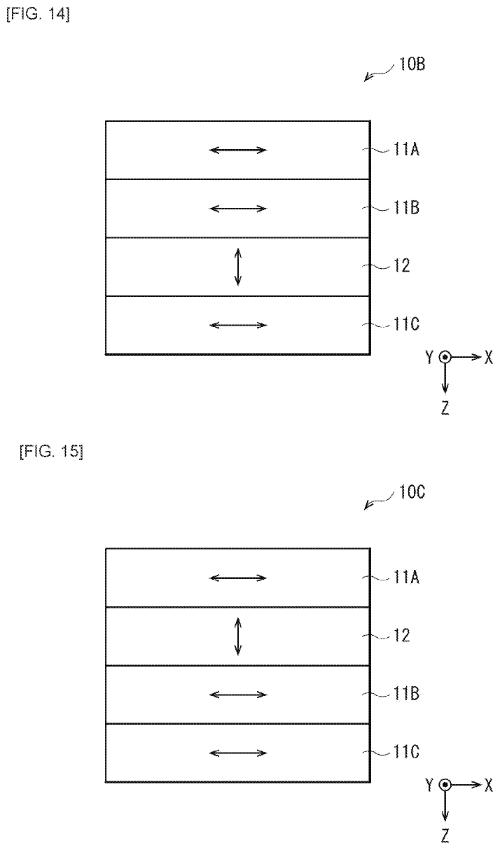

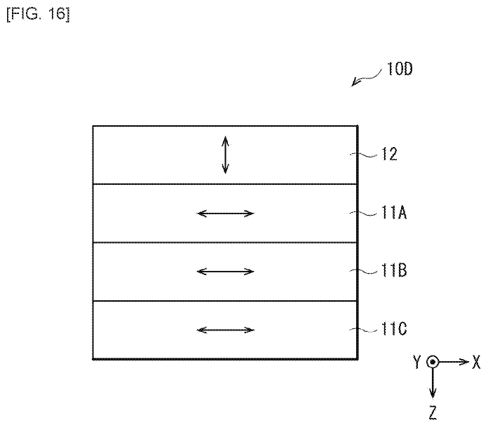

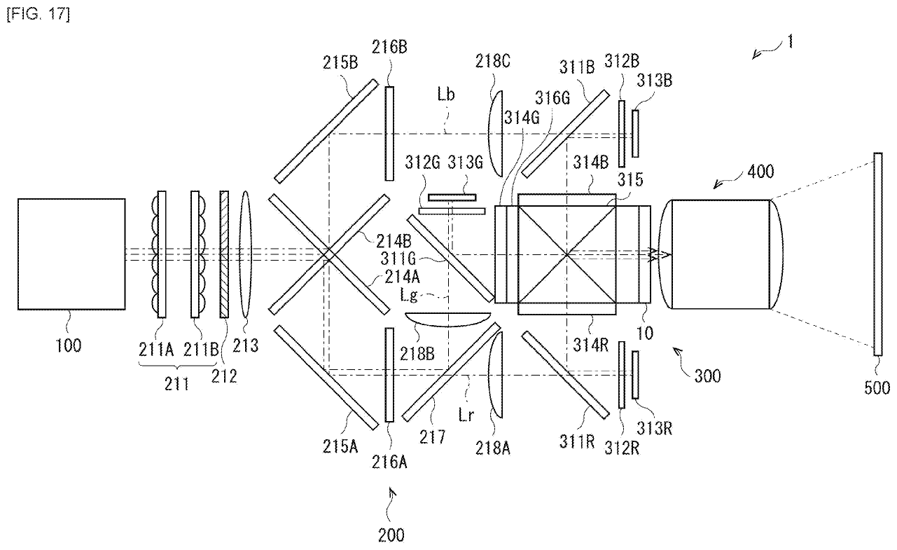

FIG. 14 to FIG. 16 schematically illustrate other examples of a cross-sectional configuration of a wavelength selective phase difference element (wavelength selective phase difference elements 10B, 10C, and 10D) according to modification examples of the present disclosure. For example, as illustrated in FIG. 14, the angle compensation layer 12 may be disposed between the second layer 11B and the third layer 1C that are included in the wavelength selective phase difference layer 11. Alternatively, for example, as illustrated in FIG. 15, the angle compensation layer 12 may be disposed between the first layer 11A and the second layer 11B that are included in the wavelength selective phase difference layer 11. Alternatively, for example, as illustrated in FIG. 16, the angle compensation layer 12 may be disposed on the light incident surface 11S1 of the wavelength selective phase difference layer 11.

By using any of the configurations described above, it is possible to offset a certain amount of optical path length difference that arises between the normal incident light L1 and the angled incident light L2 when penetrating the wavelength selective phase difference layer 11. This makes it possible to improve the angular property.

### 3. APPLICATION EXAMPLES

### Application Example 1

FIG. 17 illustrates an example of a schematic configuration of a projection display apparatus (the projector 1) including the wavelength selective phase difference element (for example, wavelength selective phase difference element 10) described in the above embodiment or the like. The projector 1 is a reflective 3LCD projector that performs light modulation by reflective liquid crystal panels (LCD). The projector 1 includes a light source 100, an illumination optical system 200, an image forming section 300, and a projection optical system 400, for example.

The light source 100 emits white light Lw including red light Lr, green light Lg, and blue light Lb, for example. For example, the light source 100 includes a plurality of light-emitting elements that emit light of a predetermined wavelength band. Examples of the plurality of light-emitting elements include an edge-emitting semiconductor laser (LD). In addition, for example, the light source 100 includes a plurality of types of light-emitting elements that emit light of different wavelength bands. The plurality of types of light-emitting elements include a red light emitting element, a green light emitting element, and a blue light emitting element. The red light emitting element emits light (red light Lr) of a wavelength band corresponding to red, the green light emitting element emits light (green light Lg) of a wavelength band corresponding to green, and the blue light emitting element emits light (blue light Lb) of a wavelength band corresponding to blue.

It is to be noted that the light source 100 is not limited to the edge-emitting lasers. Instead of the edge-emitting lasers, it is also possible to use surface-emitting lasers, lamps, light-emitting diodes (LED), or wavelength conversion elements as the plurality of light-emitting elements.

For example, the illumination optical system 200 includes an integrator element 211, a polarization conversion element 212, and a condenser lens 213.

As a whole, the integrator element 211 has a function of smoothing incident light emitted from the light source 100 to liquid crystal panels 313R, 313G, and 313B in a manner that homogeneous luminance distribution is obtained. The integrator element 211 includes a first fly-eye lens 211A and a second fly-eye lens 211B. The first fly-eye lens 211A includes a plurality of two-dimensionally disposed micro lenses. The second fly-eye lens 211B includes a plurality of micro lenses disposed in a manner that the respective micro lenses correspond to the micro lenses included in the first fly-eye lens 211A.

The polarization conversion element 212 has a function of matching polarization states of the light incident via the integrator element 211 and the like.

Light (white light Lw) that has been emitted by the light source 100 and that is incident on the integrator element 211 is divided into a plurality of light fluxes by the micro lenses included in the first fly-eye lens 211A, and an image is formed by the corresponding micro lenses included in the second fly-eye lens 211B. The respective micro lenses in the second fly-eye lens 211B function as secondary light sources, and emit a plurality of parallel light whose luminance match each other toward the polarization conversion element 212.

The illumination optical system 200 further includes dichroic mirrors 214A, 214B, and 217, reflective mirrors 215A and 215B, polarizing plates 216A and 216B, and field lenses 218A, 218B, and 218C.

The dichroic mirrors 214A and 214B correspond to specific examples of a “wavelength selection element” according to the present disclosure. The dichroic mirrors 214A and 214B have properties of selectively reflecting color light of predetermined wavelength bands and transmitting light of the other wavelength bands. For example, the dichroic mirror 214A selectively reflects the red light Lr and the green light Lb. The dichroic mirror 214B selectively reflects the blue light Lb.

The reflective mirror 215A further reflects the red light Lr and the green light Lg that have already been reflected by the dichroic mirror 214A, toward the polarizing plate 216A. The reflective mirror 215B further reflects the blue light Lb that has already been reflected by the dichroic mirror 214B, toward the polarizing plate 216B.

The polarizing plates 216A and 216B include polarizers having polarization axes of predetermined directions. For example, in a case where p-polarized light is obtained through the polarization conversion element 212, the polarizing plate 216A transmits the p-polarized light and reflects s-polarized light with regard to the red light Lr and the green light Lg. 216B transmits the p-polarized light and reflects s-polarized light with regard to the blue light Lb.

The dichroic mirror 217 selectively reflects the green light Lg and transmits the red light Lr among the red light Lr and the green light Lg emitted from the polarizing plate 216A. In such a way, the white light Lw emitted by the light source 100 is divided into a plurality of different color light beams (red light Lr, green light Lg, and blue light Lb).

The field lenses 218A, 218B, and 218C have functions of respectively collecting the red light Lr, the green light Lg, and the blue light Lb and illuminating the liquid crystal panels 313R, 313G, and 313B.

The image forming section 300 includes reflective polarizing plates 311R, 311G, and 311B, compensating plates 312R, 312G, and 312B, the liquid crystal panels 313R, 313G, and 313B, polarizing plates 314R, 314G, and 314B, and a dichroic prism 315. In addition, a λ/2 plate 316G is disposed between the polarizing plate 314G and the dichroic prism 315.

The reflective polarizing plates 311R, 311G, and 311B respectively transmit light (such as p-polarized light) having same polarization axes as polarization axes of the polarizing plates 216A and 216B, and reflect light (s-polarized light) having the other polarization axes. For example, the reflective polarizing plate 311R transmits p-polarized red light Lr toward a direction of the liquid crystal panel 313R. The reflective polarizing plate 311G transmits p-polarized green light Lg toward a direction of the liquid crystal panel 313G. The reflective polarizing plate 311B transmits p-polarized blue light Lb toward a direction of the liquid crystal panel 313B. In addition, the reflective polarizing plate 311R reflects s-polarized red light Lr from the liquid crystal panel 313R toward the dichroic prism 315. The reflective polarizing plate 311G reflects s-polarized green light Lg from the liquid crystal panel 313G toward the dichroic prism 315. The reflective polarizing plate 311B reflects s-polarized blue light Lb from the liquid crystal panel 313B toward the dichroic prism 315.

The compensating plates 312R, 312G, and 312B have a function of compensating for phase difference components generated by the liquid crystal panels 313R, 313G, and 313B when displaying black.

The liquid crystal panels 313R, 313G, and 313B correspond to specific examples of a “light modulation element” according to the present disclosure. The liquid crystal panels 313R, 313G, and 313B are electrically coupled to a signal source (such as a PC) (not illustrated) that supplies an image signal including image information. The liquid crystal panels 313R, 313G, and 313B modulate incident light for respective pixels on the basis of supplied image signals of respective colors, and generate a red image, a green image, and a blue image, respectively. The modulated light beams (formed image) of the respective colors pass through the compensating plates 312R, 312G, and 312B, the reflective polarizing plates 311R, 311G, and 311B, and the polarizing plates 314R, 314G, and 314B respectively, enter the dichroic prism 315, and are combined.

The dichroic prism corresponds to a specific example of a “color combining element” according to the present disclosure. Specifically, the red light Lr passes through the compensating plate 312R, the reflective polarizing plate 311R, and the polarizing plate 314R, enters the dichroic prism 315, and is combined. The green light Lg passes through the compensating plate 312G, the reflective polarizing plate 311G, the polarizing plate 314G, and the λ/2 plate 316G, enters the dichroic prism 315, and is combined. The blue light Lb passes through the compensating plate 312B, the reflective polarizing plate 311B, and the polarizing plate 314B, enters the dichroic prism 315, and is combined.

The respective polarizing plates 314R, 314G, and 314B are polarizers that further cut unnecessary polarized components that have not been fully cut by the reflective polarizing plates 3111A, 311G, and 311B when displaying black.

The dichroic prism 315 has three incident surfaces and one exit surface, and has a function of overlapping respective color light beams (red light Lr, green light Lg, and blue light Lb) incident on the respective incident surfaces, combining them, and emitting combined light. The dichroic prism 315 combines the incident red light Lr, green light Lg, and blue light Lb, and emits the combined light toward the projection optical system 400.

The projector 1 includes the wavelength selective phase difference element 10 disposed between the dichroic prism 315 and the projection optical system 400. For example, the wavelength selective phase difference element 10 may be adhered to the exit surface of the dichroic prism 315. Alternatively, the wavelength selective phase difference element 10 may be mechanically coupled to a light incident side of the projection optical system 400.

The red light Lr and the blue light Lb are s-polarized components, and the green light Lg is a p-polarized component, with regard to the polarized components of the color light beams incident on the dichroic prism 315 of the projector 1. In the present application example, the wavelength selective phase difference element 10 selectively performs polarization conversion of light of the green band, for example. The light of the green band is selectively converted into an s-polarized component among light beams emitted from the dichroic prism 315. This makes it possible to emit image light having polarized components that match each other, toward the projection optical system 400.

For example, the projection optical system 400 includes a plurality of lenses and the like, and enlarges light emitted by the image forming section 300 and projects the enlarged light on a screen 500.

### Application Example 2

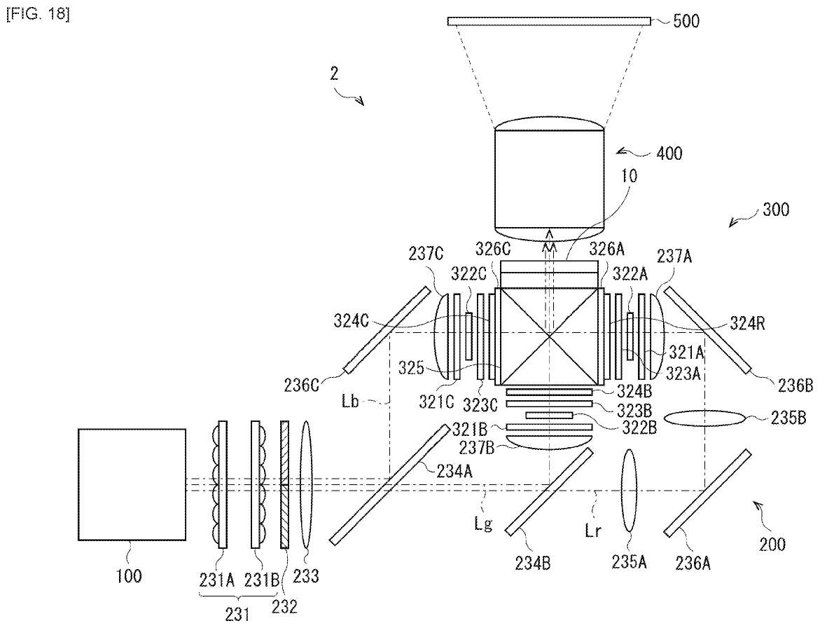

FIG. 18 illustrates another example of a schematic configuration of a projection display apparatus (a projector 2) including the wavelength selective phase difference element (for example, the wavelength selective phase difference element 10) described in the above embodiment or the like. The projector 2 is a transmissive 3LCD projector that performs light modulation by transmissive liquid crystal panels (LCD). In a way similar to the above-described projector 1, the projector 2 includes a light source 100, an illumination optical system 200, an image forming section 300, and a projection optical system 400, for example.

For example, the illumination optical system 200 includes an integrator element 231, a polarization conversion element 232, and a condenser lens 233. The illumination optical system 200 further includes dichroic mirrors 234A and 234B, relay lenses 235A and 235B, mirrors 236A, 236B, and 236C, and field lenses 237A, 237B, and 237C.

The dichroic mirrors 234A and 234B correspond to specific examples of the “wavelength selection element” according to the present disclosure. The dichroic mirrors 234A and 234B have properties of selectively reflecting color light of predetermined wavelength bands and transmitting light of the other wavelength bands. For example, the dichroic mirror 234A selectively reflects the blue light Lb. The dichroic mirror 234B selectively reflects the green light Lg among the red light Lr and the green light Lg that have passed through the dichroic mirror 234A. The remaining red light Lr passes through the dichroic mirror 234B. In such a way, the white light Lw emitted by the light source 100 is divided into a plurality of different color light beams (red light Lr, green light Lg, and blue light Lb).

The red light Lr passes through the relay lens 235A, is reflected by the mirror 236A, further passes through the relay lens 235B, and then is reflected by the mirror 236B. The red light Lr reflected by the mirror 236B passes through the field lens 237A, is parallelized, and then enters a liquid crystal panel 322A for modulating the red light Lr. The green light Lg passes through the field lens 237B, is parallelized, and then enters a liquid crystal panel 322B for modulating the green light. The divided blue light Lb is reflected by the mirror 236C, passes through the field lens 237C, is parallelized, and then enters a liquid crystal panel 322C for modulating the blue light Lb.

Incident-side polarizing plates 321A, 321B, and 321C have functions of further matching polarized light that has already been matched by the polarization conversion element 232 (cutting unnecessary polarized light).

The liquid crystal panels 322A, 322B, and 322C correspond to specific examples of the “light modulation element” according to the present disclosure. The liquid crystal panels 322A, 322B, and 322C are electrically coupled to a signal source (for example, PC or the like) (not illustrated) that supplies an image signal including image information. The liquid crystal panels 322A, 322B, and 322C modulate incident light for respective pixels on the basis of supplied image signals of respective colors, and generate a red image, a green image, and a blue image, respectively. Among the modulated light beams (formed image) of the respective colors, the red light Lr passes through an exit-side pre-polarizing plate 323A, an exit-side main polarizing plate 324A, and a λ/2 plate 326A, and enters a dichroic prism 325. The green light Lg passes through an exit-side pre-polarizing plate 323B and an exit-side main polarizing plate 324B, and enters the dichroic prism 325. The blue light Lb passes through an exit-side pre-polarizing plate 323C, an exit-side main polarizing plate 324C, and a λ/2 plate 326C, and enters the dichroic prism 325. In such a way, the modulated light beams (formed image) of the respective colors is combined by the dichroic prism 325d.

The exit-side pre-polarizing plates 323A, 323B, and 323C cut polarized light that is unnecessary when the respective liquid crystal panels 322A, 322B, and 322C displays black. The exit-side main polarizing plates 324A, 324B, and 324C further cut unnecessary polarized light that has not been fully cut by the respective exit-side pre-polarizing plates 323A, 323B, and 323C. The dichroic prism 325 has three incident surfaces and one exit surface, and has a function of overlapping respective color light beams (red light Lr, green light Lg, and blue light Lb) incident on the respective incident surfaces, combining them, and emitting combined light.

The projector 2 includes the wavelength selective phase difference element 10 disposed between the dichroic prism 325 and the projection optical system 400.

The red light Lr and the blue light Lb are s-polarized components, and the green light Lg is a p-polarized component, with regard to the polarized components of the color light beams incident on the dichroic prism 325 of the projector 2. In the present application example, the wavelength selective phase difference element 10 selectively performs polarization conversion of light of the green band, for example. The light of the green band is selectively converted into an s-polarized component among light beams emitted from the dichroic prism 325. This makes it possible to emit image light having polarized components that match each other, toward the projection optical system 400.

For example, the projection optical system 400 includes a plurality of lenses and the like, and enlarges light emitted by the image forming section 300 and projects the enlarged light on a screen 500.

### Application Example 3

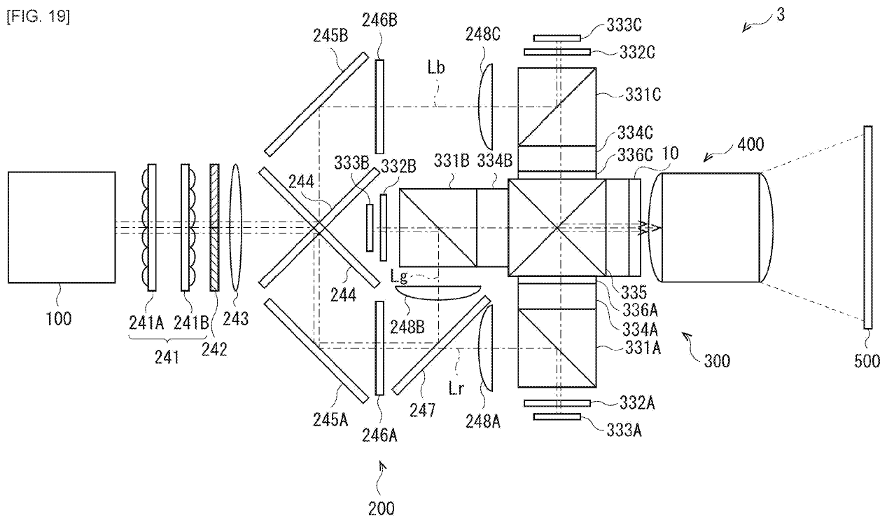

FIG. 19 illustrates another example of a schematic configuration of a projection display apparatus (a projector 3) including the wavelength selective phase difference element (for example, wavelength selective phase difference element 10) described in the above embodiment or the like. The projector 3 is a reflective 3LCD projector that performs light modulation by reflective liquid crystal panels (LCD). In a way similar to Application Example 1 described above, the projector 3 includes a light source 100, an illumination optical system 200, an image forming section 300, and a projection optical system 400, for example.

For example, the illumination optical system 200 includes an integrator element 241, a polarization conversion element 242, and a condenser lens 243. The illumination optical system 200 further includes dichroic mirrors 244 and 247, reflective mirrors 245A and 245B, polarizing plates 246A and 246B, and field lenses 248A, 248B, and 248C.

The image forming section 300 includes polarizing beam splitters (PBS) 331A, 331B, 331C, quarter-wave plates 332A, 332B, 332C, liquid crystal panels 333A, 333B, 333C, spacers 334A, 334B, 334C, and a dichroic prism 335. In addition, a λ/2 plate 336A is disposed between the spacer 334A and the dichroic prism 335, and a λ/2 plate 336C is disposed between the spacer 334C and the dichroic prism 335.

The dichroic mirrors 244 correspond to specific examples of the “wavelength selection element” according to the present disclosure. The dichroic mirrors 244 divide the white light Lw into a blue light Lb and the other color light (red light Lr and green light Lg). The red light Lr and the green light Lg that have been divided by the dichroic mirrors 244 are reflected by the reflective mirror 245A, pass through the polarizing plate 246A, and enter the dichroic mirror 247. The dichroic mirror 247 selectively reflects the green light Lg and transmits the red light Lr among the red light Lr and the green light Lg. In such a way, the white light Lw emitted by the light source 100 is divided into a plurality of different color light beams (red light Lr, green light Lg, and blue light Lb).

The red light Lr and the green light Lg that have been divided pass through the field lenses 248A and 248B and enter the PBSs 331A and 331B, respectively. The blue light Lb is reflected by the reflective mirror 245B, passes through the polarizing plate 246B and the field lens 248C, and enters the PBS 331C.

The PBSs 331A, 331B, and 331C have respective polarization selection surfaces, and use the respective polarization selection surfaces to select (reflect) light of a predetermined polarized component (for example, s-polarized component) incident on the liquid crystal panels 333A, 333B, and 333C. In addition, the PBSs 331A, 331B, and 331C have functions of selecting (transmitting) light of a predetermined polarized component (for example, p-polarized component) from among light beams reflected by the liquid crystal panels 333A, 333B, and 333C, and emitting the selected light. The projector 3 has an optical arrangement in such a manner that the PBSs 331A, 331B, and 331C reflect the light of the s-polarized component, the light of the s-polarized component is incident on the liquid crystal panels 333A, 333B, and 333C, and the PBSs 331A, 331B, and 331C transmit light of a p-polarized component as light to be emitted, among light beams returned from the liquid crystal panels 333A, 333B, and 333C.

The quarter-wave plates 332A, 332B, and 332C correct polarization states between the PBS 331A and the liquid crystal panel 333A, between the PBS 331B and the liquid crystal panel 333B, and between the PBS 331C and the liquid crystal panel 333C, and generate a phase difference of nearly quarter wavelength for light of polarization components orthogonal to each other. It is to be noted that the quarter-wave plates 332A, 332B, and 332C may be implemented by the wavelength selective phase difference elements 10 according to the present disclosure.

The red light Lr, the green light Lg, and the blue light Lb respectively pass through the field lenses 248A, 248B, and 248C, enter the PBSs 331A, 331B, and 331C, and light of predetermined polarized components is reflected by the respective polarization selection surfaces of the PBSs 331A, 331B, and 331C among the red light Lr, the green light Lg, and the blue light Lb. The red light Lr, the green light Lg, and the blue light Lb of the predetermined polarized components reflected by the polarization selection surfaces pass through the quarter-wave plates 332A, 332B, and 332C, and enter the liquid crystal panels 333A, 333B, and 333C, respectively. The liquid crystal panels 333A, 333B, and 333C modulate incident light for respective pixels on the basis of supplied image signals of respective colors, and generate a red image, a green image, and a blue image, respectively. Among the modulated light beams (formed image) of the respective colors, the red light Lr is reflected toward the PBS 331A, passes through the quarter-wave plate 332A, the PBS 331A, the spacer 334A, and the λ/2 plate 336A, and enters the dichroic prism 335. The green light Lg is reflected toward the PBS 331A, passes through the quarter-wave plate 332B, the PBS 331B, and the spacer 334B, and enters the dichroic prism 335. The blue light Lb is reflected toward the PBS 331C, passes through the quarter-wave plate 332C, the PBS 331C, the spacer 334C, and the λ/2 plate 336C, and enters the dichroic prism 335. In such a way, the modulated light beams (formed image) of the respective colors is combined by the dichroic prism 335.

The projector 3 includes the wavelength selective phase difference element 10 disposed between the dichroic prism 335 and the projection optical system 400.

The red light Lr and the blue light Lb are s-polarized components, and the green light Lg is a p-polarized component, with regard to the polarized components of the color light beams incident on the dichroic prism 335 of the projector 3. In the present application example, the wavelength selective phase difference element 10 selectively performs polarization conversion of light of the green band, for example. The light of the green band is selectively converted into an s-polarized component among light beams emitted from the dichroic prism 335. This makes it possible to emit image light having polarized components that match each other, toward the projection optical system 400.

For example, the projection optical system 400 includes a plurality of lenses and the like, and enlarges light emitted by the image forming section 300 and projects the enlarged light on a screen 500.

### Application Example 4

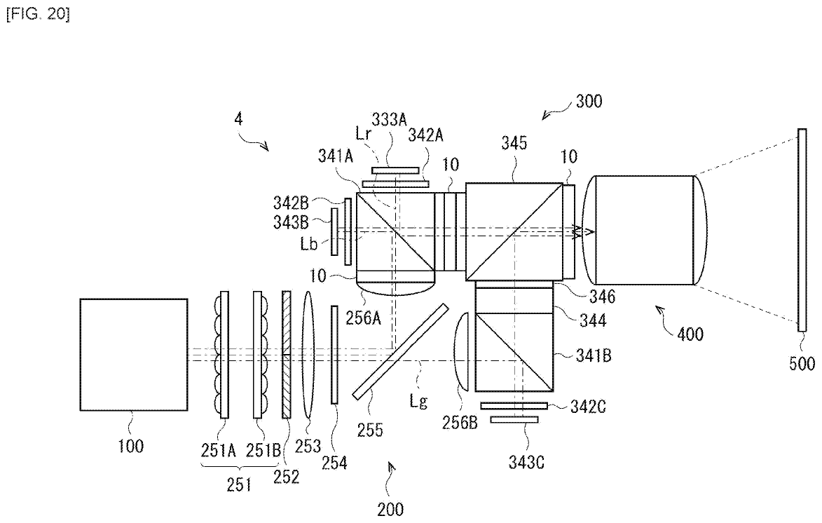

FIG. 20 illustrates another example of a schematic configuration of a projection display apparatus (projector 4) including the wavelength selective phase difference element (for example, wavelength selective phase difference element 10) described in the above embodiment or the like. The projector 4 is a reflective 3LCD projector that performs light modulation by reflective liquid crystal panels (LCD). In a way similar to Application Example 1 described above, the projector 3 includes a light source 100, an illumination optical system 200, an image forming section 300, and a projection optical system 400, for example.

For example, the illumination optical system 200 includes an integrator element 251, a polarization conversion element 252, and a condenser lens 253. The illumination optical system 200 further includes a polarizing plate 254, a dichroic mirror 255, and field lenses 256A and 256B.

The image forming section 300 includes PBS 341A, 341B, and 345, quarter-wave plates 342A, 342B, and 342C, liquid crystal panels 343A, 343B, and 343C, and a spacer 344. In addition, a λ/2 plate 346 is disposed between the spacer 344 and a dichroic prism 315.

The projector 4 includes a wavelength selective phase difference element 10 disposed between the dichroic prism 345 and the projection optical system 400, a wavelength selective phase difference element 10 disposed between the field lens 255A and the PBS 341A, and a wavelength selective phase difference element 10 disposed between the PBS 341A and the PBS 345.

In ways similar to Application Examples 1 to 3 described above, the wavelength selective phase difference element 10 disposed between the dichroic prism 345 and the projection optical system 400 selectively performs polarization conversion of light of the green band, for example. The light of the green band is selectively converted into a p-polarized component among light beams emitted from the dichroic prism 345. This makes it possible to emit image light having polarized components that match each other, toward the projection optical system 400.

The wavelength selective phase difference element 10 disposed between the field lens 255A and the PBS 341A selectively rotates a polarization direction of light of a red band among the red band and the blue band (light of the blue band is reflected while its polarization direction is maintained). It is sufficient to design the wavelength selective phase difference element 10 only in view of its performance related to at least two wavelength bands (here, red light Lr and blue light Lb), and it is not necessary to consider all wavelengths including red, green, and blue (RGB) (property related to green band is optional).

The wavelength selective phase difference element 10 disposed between the PBS341A and the PBS 345 selectively rotates a polarization direction of light of a red band among the red band and the blue band (light of the blue band is transmitted while its polarization direction is maintained). In a way similar to the above, it is sufficient to design the wavelength selective phase difference element 10 only in view of its performance related to at least two wavelength bands (here, red light Lr and blue light Lb), and it is not necessary to consider all wavelengths including red, green, and blue (RGB).

For example, the projection optical system 400 includes a plurality of lenses and the like, and enlarges light emitted by the image forming section 300 and projects the enlarged light on a screen 500.

### Application Example 5

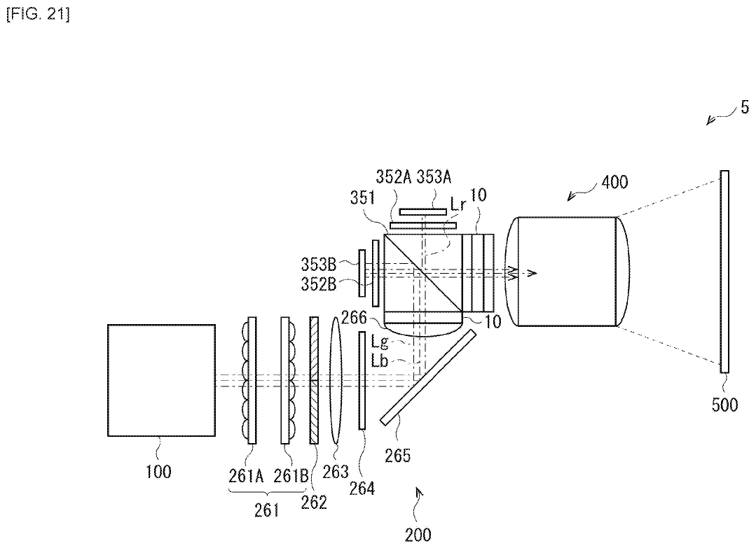

FIG. 21 illustrates another example of a schematic configuration of a projection display apparatus (a projector 5) including the wavelength selective phase difference element (for example, the wavelength selective phase difference element 10) described in the above embodiment or the like. The projector 4 is a reflective 2LCD projector that performs light modulation by two reflective liquid crystal panels (LCD). In a way similar to Application Example 1 described above, the projector 3 includes a light source 100, an illumination optical system 200, an image forming section 300, and a projection optical system 400, for example.

For example, the illumination optical system 200 includes an integrator element 261, a polarization conversion element 262, and a condenser lens 263. The illumination optical system 200 further includes a polarizing plate 264, a mirror 265, and a field lens 266.

The image forming section 300 includes a PBS 351, quarter-wave plates 352A and 352B, and liquid crystal panels 353A and 353B.

The PBS 351 separates light of a predetermined wavelength band on the basis of its polarization direction. For example, the wavelength selective PBS 351 reflects an s-polarized component and transmits a p-polarized component. The projector 5 selectively reflects blue light Lb and green light Lg that have s-polarized components on a wavelength selection surface, and transmits red light Lr having a p-polarized component.

Each of the liquid crystal panels 353A and 353B modulates incident light, and emits modulated light. For example, the liquid crystal panels 353A and 353B modulate illumination light on the basis of a picture signal, and emit the modulated illumination light. In this case, the liquid crystal panels 353A and 353B convert light into polarized light that is orthogonal to incident polarized light, and emit the converted light.

The projector 5 includes a wavelength selective phase difference element 10 disposed between the PBS 351 and the projection optical system 400, and a wavelength selective phase difference element 10 disposed between the field lens 266 and the PBS 531.

For example, the wavelength selective phase difference element 10 disposed between the PBS 351 and the projection optical system 400 selectively performs polarization conversion of light of the green band and blue band. The light of the green band and blue band is selectively converted into s-polarized components among light beams emitted from the PBS 351. This makes it possible to emit image light having polarized components that match each other, toward the projection optical system 400.

The wavelength selective phase difference element 10 disposed between the field lens 266 and the PBS 351 selectively rotates polarization directions of light of the green band and blue band among the red band, the green band, and the blue band (light of the red band is transmitted while its polarization direction is maintained).

For example, the projection optical system 400 includes a plurality of lenses and the like, and enlarges light emitted by the image forming section 300 and projects the enlarged light on a screen 500.

The present technology has been described above with reference to the embodiment, modification examples, and application examples. However, the present technology is not limited thereto, and various kinds of modifications thereof can be made. For example, the projectors 1 to 5, each of which uses the single light source 100 for emitting white light Lw, have been described above as the examples. However, the present disclosure is not limited thereto. For example, each of the projectors 1 to 5 may include a plurality of light sources (red light source, green light source, and blue light source) that respectively emit red light Lr, green light Lg, and blue light Lb.

Alternatively, a device other than the projectors 1 to 5 may be used as the projection display apparatus according to the present technology. For example, the examples in which the projectors 1 to 5 use the reflective liquid crystal panels or transmissive liquid crystal panels as the light modulation elements have been described above. However, the present technology is applicable to a projector using a digital micromirror device (DMD) or the like.

It is to be noted that the present disclosure is not limited to the effect stated above and may achieve any of the effects described in this specification.

It is to be noted that the present technology may also have the following configurations. According to the present technology of the following configurations, when the three axes including the X axis, the Y axis, and the Z axis are orthogonal to one another, the second member having the optical axis parallel to the Z-axis direction is disposed on the light output surface of the first member having a multi-layer structure where a plurality of layers are stacked between the light output surface and the light incident surface that are opposed to each other in the Z-axis direction. This makes it possible to offset an optical path length difference that arises when light incident perpendicularly on the first member and the light incident obliquely on the first member penetrate the first member. Accordingly, it is possible to improve the angular property.

(1)

A wavelength selective phase difference element including:
a light incident surface and a light output surface that are opposed to each other in a Z-axis direction when three axes including an X axis, a Y axis, and a Z axis are orthogonal to one another;
a first member that has a multi-layer structure where a plurality of layers are stacked between the light incident surface and the light output surface; and
a second member that is disposed on the light output surface of the first member and has an optical axis parallel to the Z-axis direction.
   (2)

The wavelength selective phase difference element according to (1), in which the respective layers included in the first member have different optical axes, each of which is parallel to a plane including the X axis and the Y axis.

(3)

The wavelength selective phase difference element according to (1) or (2), in which
the first member includes a first layer that is disposed on the light output surface as one of the plurality of layers, and
the first layer has an optical axis to allow an absolute value of an angle formed between a perpendicular line to the optical axis and a reference side that is parallel or perpendicular to a vibration direction of incident polarization light to be about 45 degrees.
   (4)

The wavelength selective phase difference element according to any one of (1) to (3), in which the plurality of layers included in the first member are bonded to each other.

(5)

The wavelength selective phase difference element according to any one of (1) to (4), in which the first member has a thickness of 0.010 mm or more and 3.000 mm or less in the Z-axis direction.

(6)

The wavelength selective phase difference element according to any one of (1) to (5), in which the first member includes a phase difference material.

(7)

The wavelength selective phase difference element according to (6), in which the phase difference material includes a uniaxial crystal or a uniaxial organic material.

(8)

The wavelength selective phase difference element according to (6) or (7), in which the phase difference material includes crystal, sapphire, yttrium vanadate, lithium niobate, polycarbonate, or polypropylene.

(9)

A projection display apparatus including:
one or a plurality of light sources that emits light beams of a plurality of wavelength bands different from one another;
a wavelength selection element that transmits or reflects light having a predetermined wavelength component among the light beams emitted from the light source;
a plurality of light modulation elements that modulates respective light beams of the plurality of wavelength bands;
a color combining element that combines the respective light beams of the wavelength bands emitted from the plurality of modulation elements;
a projection optical system that projects light emitted from the color combining element; and
a wavelength selective phase difference element that is disposed on a light output side of the wavelength selection element,
in which the wavelength selective phase difference element includes
   a light incident surface and a light output surface that are opposed to each other in a Z-axis direction when three axes including an X axis, a Y axis, and a Z axis are orthogonal to one another,
   a first member that has a multi-layer structure where a plurality of layers are stacked between the light incident surface and the light output surface, and
   a second member that is disposed on the light output surface of the first member and includes an optical axis parallel to the Z-axis direction.
      (10)

The projection display apparatus according to (9), in which the wavelength selective phase difference element is disposed between any adjacent components selected from the wavelength selection element, the light modulation elements, the color combining element, and the projection optical system.

(11)

The projection display apparatus according to (9) or (10), in which the wavelength selective phase difference element selectively performs polarization conversion of light of a predetermined wavelength band among the plurality of wavelength bands.

(12)

The projection display apparatus according to any one of (9) to (11), in which the plurality of wavelength bands includes a green band, a blue band, and a red band.

(13)

The projection display apparatus according to any one of (9) to (12), in which the one light source includes a white light source that emits white light.

(14)

The projection display apparatus according to any one of (9) to (13), in which the plurality of light sources includes a green light source that emits light of a green band, a blue light source that emits light of a blue band, and a red light source that emits light of a red band.

(15)

The projection display apparatus according to any one of (9) to (14), in which the color combining element includes a polarizing beam splitter, a dichroic prism, or a dichroic mirror.

The present application claims the benefit of Japanese Priority Patent Application JP2021-066053 filed with the Japan Patent Office on Apr. 8, 2021, the entire contents of which are incorporated herein by reference.

It should be understood by those skilled in the art that various modifications, combinations, sub-combinations and alternations may occur depending on design requirements and other factors insofar as they are within the scope of the appended claims or the equivalents thereof.

1. A wavelength selective phase difference element comprising:
a light incident surface and a light output surface that are opposed to each other in a Z-axis direction when three axes including an X axis, a Y axis, and a Z axis are orthogonal to one another;
a first member that has a multi-layer structure where a plurality of layers are stacked between the light incident surface and the light output surface; and
a second member that is disposed on the light output surface of the first member and has an optical axis parallel to the Z-axis direction.

2. The wavelength selective phase difference element according to claim 1, wherein the respective layers included in the first member have different optical axes, each of which is parallel to a plane including the X axis and the Y axis.

3. The wavelength selective phase difference element according to claim 1, wherein
the first member includes a first layer that is disposed on the light output surface as one of the plurality of layers, and
the first layer has an optical axis to allow an absolute value of an angle formed between a perpendicular line to the optical axis and a reference side that is parallel or perpendicular to a vibration direction of incident polarization light to be about 45 degrees.

4. The wavelength selective phase difference element according to claim 1, wherein the plurality of layers included in the first member are bonded to each other.

5. The wavelength selective phase difference element according to claim 1, wherein the first member has a thickness of 0.010 mm or more and 3.000 mm or less in the Z-axis direction.

6. The wavelength selective phase difference element according to claim 1, wherein the first member includes a phase difference material.

7. The wavelength selective phase difference element according to claim 6, wherein the phase difference material comprises a uniaxial crystal or a uniaxial organic material.

8. The wavelength selective phase difference element according to claim 6, wherein the phase difference material comprises crystal, sapphire, yttrium vanadate, lithium niobate, polycarbonate, or polypropylene.

9. A projection display apparatus comprising:
one or a plurality of light sources that emits light beams of a plurality of wavelength bands different from one another;
a wavelength selection element that transmits or reflects light having a predetermined wavelength component among the light beams emitted from the light source;
a plurality of light modulation elements that modulates respective light beams of the plurality of wavelength bands;
a color combining element that combines the respective light beams of the wavelength bands emitted from the plurality of modulation elements;
a projection optical system that projects light emitted from the color combining element; and
a wavelength selective phase difference element that is disposed on a light output side of the wavelength selection element, wherein
the wavelength selective phase difference element includes
a light incident surface and a light output surface that are opposed to each other in a Z-axis direction when three axes including an X axis, a Y axis, and a Z axis are orthogonal to one another,
a first member that has a multi-layer structure where a plurality of layers are stacked between the light incident surface and the light output surface, and
a second member that is disposed on the light output surface of the first member and has an optical axis parallel to the Z-axis direction.

10. The projection display apparatus according to claim 9, wherein the wavelength selective phase difference element is disposed between any adjacent components selected from the wavelength selection element, the light modulation elements, the color combining element, and the projection optical system.

11. The projection display apparatus according to claim 9, wherein the wavelength selective phase difference element selectively performs polarization conversion of light of a predetermined wavelength band among the plurality of wavelength bands.

12. The projection display apparatus according to claim 9, wherein the plurality of wavelength bands comprises a green band, a blue band, and a red band.

13. The projection display apparatus according to claim 9, wherein the one light source comprises a white light source that emits white light.

14. The projection display apparatus according to claim 9, wherein the plurality of light sources includes a green light source that emits light of a green band, a blue light source that emits light of a blue band, and a red light source that emits light of a red band.

15. The projection display apparatus according to claim 9, wherein the color combining element comprises a polarizing beam splitter, a dichroic prism, or a dichroic mirror.
